(19) United States
(12) Patent Application Publication
(10) Pub. No.: US 2025/0118937 A1
(43) Pub. Date: Apr. 10, 2025

(54) Emergency Power Plug Device

(71) Applicant: Lionel Moore, Columbus, OH (US)

(72) Inventor: Lionel Moore, Columbus, OH (US)

(21) Appl. No.: 18/904,201

(22) Filed: Oct. 2, 2024

Related U.S. Application Data
(60) Provisional application No. 63/588,061, filed on Oct. 5, 2023.

(51) Int. Cl. H01R 24/30; H01R 13/502; H01R 13/73; H01R 24/22; H01R 105/00

(52) U.S. Cl. CPC H01R 24/30; H01R 13/502; H01R 13/73; H01R 24/22; H01R 2105/00

(57) ABSTRACT

An emergency power plug device is provided. The device is designed to facilitate the connection of an appliance to a generator 20, ensuring the appliance can be powered by an alternative power source. The device comprises a body with a first end and a second end. The first end includes at least one wire, with a positive, a negative, and a ground wire for hardwiring into an appliance, like a furnace, providing direct electrical communication. The first end may also feature threads and a threaded locking nut for secure attachment to the appliance. The second end features a plug, adaptable to be either a male or female 3-prong outlet plug, designed for connection to a generator 20 or portable power source.

### CROSS-REFERENCE TO RELATED APPLICATION

The present application claims priority to, and the benefit of, U.S. Provisional Application No. 63/588,061, which was filed on Oct. 5, 2023, and is incorporated herein by reference in its entirety.

### FIELD OF THE INVENTION

The present invention relates generally to the field of generators. More specifically, the present invention relates to an emergency power plug device that can be connected to a generator and can be universally hardwired to an appliance to ensure generator compatibility. Accordingly, the present disclosure makes specific reference thereto. Nonetheless, it is to be appreciated that aspects of the present invention are also equally applicable to other like applications, devices, and methods of manufacture.

### BACKGROUND

During power outages, individuals often find themselves in challenging situations due to the inability to operate essential household appliances such as furnaces, refrigerators, etc. This can result in discomfort, food spoilage, and in extreme cases, hazardous living conditions, especially during severe weather conditions. Generators, often considered a reliable backup solution, may not always provide a viable alternative. The compatibility of generators with certain appliances can be an issue, as not all devices are designed to function with the type of power supply that generators provide. Moreover, the capacity of generators is limited; they can only support a certain number of appliances at once, necessitating tough choices about which devices are essential during the outage.

Additionally, the challenges compound for those residing in remote or rural areas. In these locations, the infrastructure for electricity can be less reliable, and in some cases, non-existent. People living in such areas might not have regular access to electricity, making them more vulnerable during power outages.

Therefore, there exists a long-felt need in the art for a device that facilitates the powering of an appliance via a generator. There also exists a long-felt need in the art for an emergency power plug device. More specifically, there exists a long-felt need in the art for an emergency power plug device that can be hardwired to an appliance and connected to a generator such that the generator supplies power to the appliance.

The subject matter disclosed and claimed herein, in one embodiment thereof, comprises an emergency power plug device. The device is designed to facilitate the connection of an appliance to a generator, ensuring the appliance can be powered by an alternative power source. The device comprises a body with a first end and a second end. The first end includes at least one wire, with a positive, a negative, and a ground wire for hardwiring into an appliance, like a furnace, providing direct electrical communication. The first end may also feature threads and a threaded locking nut for secure attachment to the appliance. The second end features a plug, adaptable to be either a male or female 3-prong outlet plug, designed for connection to a generator or portable power source. To protect the plug when not in use, it can be covered with a cap, which may be either fixedly attached or removably connected to the device and secured with a locking member such as a button.

In this manner, the emergency power plug device of the present invention accomplishes all the forgoing objectives and provides a device that facilitates the powering of an appliance via a generator. More specifically, the device can be hardwired to an appliance and connected to a generator such that the generator supplies power to the appliance. As a result, the device provides universal power capability between an appliance and a generator.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an emergency power plug device comprised of a power plug that can be easily hardwired into an appliance that provides a means to plug said appliance into a generator. The device is comprised of a body comprised of a first end and a second end.

The first end is comprised of at least one wire. The wire may be a positive, negative, and/or neutral wire. The wire can be used to hardwire the device into wired electrical communication with an appliance (such as but not limited to a furnace) in one embodiment. More specifically, the first end may be comprised of at least one thread that allows the first end to threadedly attach to an existing threaded attachment point of an appliance.

The second end of the body is comprised of at least one plug that allows the device to be plugged into a generator (or other portable power source) to provide power to the appliance connected to the wire of the first end. When not in use, the plug can be protected by at least one cap.

The present invention is also comprised of a method of using the device. First, a device is provided comprised of a body comprised of a first end comprised of at least one wire and a second end comprised of at least one plug. Then, the wire can be attached in wired electric communication to an appliance such as but not limited to a furnace, a freezer, a refrigerator, etc. Next at least one thread of the first end can be attached to at least one thread of the appliance, and wherein the first end can further be secured to the appliance via at least one nut that attaches to the threads of the third end and/or the threads of the appliance. Finally, the plug of the second end can be used to place the appliance in wired electrical communication with a generator or other portable power source.

Accordingly, the emergency power plug device of the present invention is particularly advantageous as it provides a device that facilitates the powering of an appliance via a generator. More specifically, the device can be hardwired to an appliance and connected to a generator such that the generator supplies power to the appliance. As a result, the device provides universal power capability between an appliance and a generator. In this manner, the emergency power plug device overcomes the limitations of backup powering methods and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an emergency power plug device of the present invention in accordance with the disclosed architecture;

FIG. 2 illustrates a perspective view of one potential embodiment of an emergency power plug device of the present invention in accordance with the disclosed architecture;

FIG. 3 illustrates a perspective view of one potential embodiment of an emergency power plug device of the present invention while connected to an appliance and a generator in accordance with the disclosed architecture; and

FIG. 4 illustrates a flowchart of a method of using one potential embodiment of an emergency power plug device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that facilitates the powering of an appliance via a generator. There also exists a long-felt need in the art for an emergency power plug device. More specifically, there exists a long-felt need in the art for an emergency power plug device that can be hardwired to an appliance and connected to a generator such that the generator supplies power to the appliance.

The present invention, in one exemplary embodiment, is comprised of an emergency power plug device. The device is comprised of a power plug that can be easily hardwired into an appliance that provides a means to plug said appliance into a generator. The device is comprised of a body comprised of a first end and a second end.

The first end is comprised of at least one wire that may be a positive, negative, and/or neutral wire. The wire can be used to hardwire the device into wired electrical communication with an appliance (such as but not limited to a furnace) in one embodiment. More specifically, the first end may be comprised of at least one thread that allows the first end to threadedly attach to an existing threaded attachment point of an appliance.

The second end of the body is comprised of at least one plug that allows the device to be plugged into a generator (or other portable power source) to provide power to the appliance connected to the wire of the first end. When not in use, the plug can be protected by at least one cap.

The present invention is also comprised of a method of using the device. First, a device is provided comprised of a body comprised of a first end comprised of at least one wire and a second end comprised of at least one plug. Then, the wire can be attached in wired electric communication to an appliance such as but not limited to a furnace, a freezer, a refrigerator, etc. Next at least one thread of the first end can be attached to at least one thread of the appliance, and wherein the first end can further be secured to the appliance via at least one nut that attaches to the threads of the third end and/or the threads of the appliance. Finally, the plug of the second end can be used to place the appliance in wired electrical communication with a generator or other portable power source.

Accordingly, the emergency power plug device of the present invention is particularly advantageous as it provides a device that facilitates the powering of an appliance via a generator. More specifically, the device can be hardwired to an appliance and connected to a generator such that the generator supplies power to the appliance. As a result, the device provides universal power capability between an appliance and a generator. In this manner, the emergency power plug device overcomes the limitations of backup powering methods and devices known in the art.

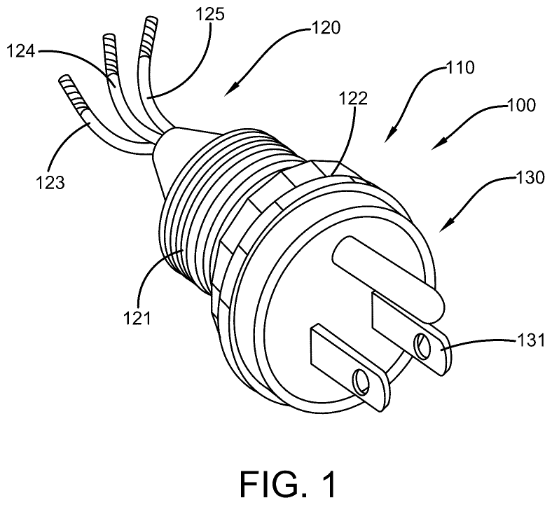

Referring initially to the drawings, FIG. 1 illustrates a perspective view of one potential embodiment of an emergency power plug device 100 of the present invention in accordance with the disclosed architecture. The device 100 is comprised of a power plug that can be easily hardwired into an appliance 10 that provides a means to plug said appliance 10 into a generator 20. The device 100 is comprised of a body 110. The body 110 is comprised of a first end 120 and a second end 130.

The first end 120 is comprised of at least one wire 123,124,125. The first wire 123 is preferably a positive wire. The second wire 124 is preferably a negative wire. The third wire 125 is preferably a ground wire. The wires 123,124,125 may be any voltage, type, and configuration of electrical wire known in the art. The wires 123,124,125 are preferably coated wires for protection. The wires 123,124,125 can be used to hardwire the device 100 into wired electrical communication with an appliance 10 (such as but not limited to a furnace) in one embodiment.

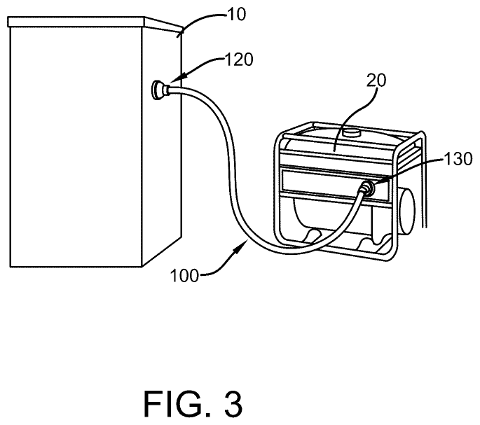

More specifically, the first end 120 may be comprised of at least one thread 121 that allows the first end 120 to threadedly attach to an existing threaded attachment point of an appliance 10, as seen in FIG. 3. To further secure the first end 120 and thread 121 to the generator 20, the first end 120 may also be comprised of at least one threaded locking nut 122 or other similar fastener of the like that attaches to the threads 121 of the first end 120 and/or the threads of the appliance 10.

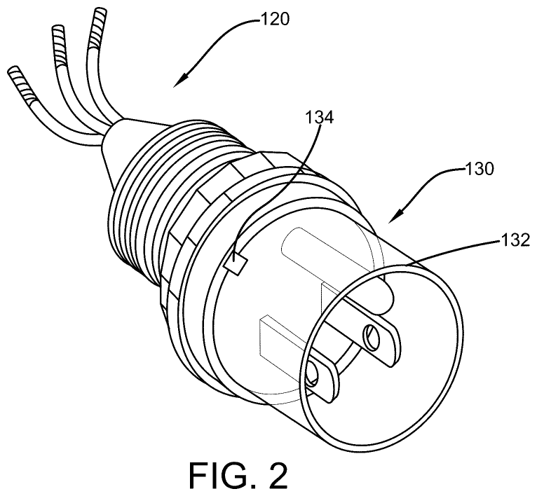

The second end 130 of the body 110 is comprised of at least one plug 131. The plug 131 may be a male or female 3-prong outlet plug. The plug 131 allows the device 100 to be plugged into a generator 20 (or other portable power source), as seen in FIG. 3, to provide power to the appliance 10 connected to the wires 123,124,125 of the first end 120. When not in use, the plug 131 can be protected by at least one cap 132, as seen in FIG. 2. In one embodiment, the cap 132 is fixedly attached to the second end 130 via a tether or other similar structure. In another embodiment, the cap 131 removably attaches to the second end 130. In one embodiment, the cap 132 can be secured in a closed position over the plug 131 via at least one locking member 134 such as but not limited to a locking button.

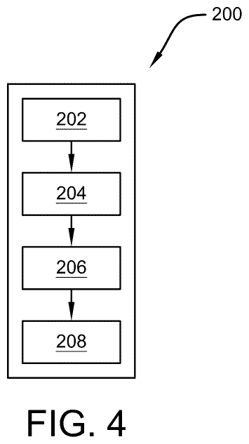

The present invention is also comprised of a method of using 200 the device 100, as seen in FIG. 4. First, a device 100 is provided comprised of a body 110 comprised of a first end 120 comprised of at least one wire 123,124,125 and a second end 130 comprised of at least one plug 131 [Step 202]. Then, the wire 123,124,125 can be attached in wired electric communication to an appliance 10 such as but not limited to a furnace, a freezer, a refrigerator, etc. [Step 204]. Next at least one thread 121 of the first end 120 can be attached to at least one thread of the appliance 10, and wherein the first end 120 can further be secured to the appliance 10 via at least one nut 122 that attaches to the threads 121 of the third end 120 and/or the threads of the appliance 10 [Step 206]. Finally, the plug 131 of the second end 130 can be used to place the appliance 10 in wired electrical communication with a generator 20 or other portable power source by attaching the plug to a structure of the generator and/or portable power source [Step 208].

It should be noted that any component of the device 100 may be made from any material.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “emergency power plug device” and “device” are interchangeable and refer to the emergency power plug device 100 of the present invention.

Notwithstanding the forgoing, the emergency power plug device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the emergency power plug device 100 as shown in the FIGS. are for illustrative purposes only, and that many other sizes and shapes of the emergency power plug device 100 are well within the scope of the present disclosure. Although the dimensions of the emergency power plug device 100 are important design parameters for user convenience, the emergency power plug device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An emergency power plug device comprising:
a first end comprised of a wire; and
a second end comprised of a plug and a cap.

2. The emergency power plug device of claim 1, wherein the wire is comprised of a coated wire.

3. The emergency power plug device of claim 1, wherein the first wire is comprised of a positive wire.

4. The emergency power plug device of claim 1, wherein the second wire is comprised of a negative wire.

5. The emergency power plug device of claim 1, wherein the third wire is comprised of a neutral wire.

6. The emergency power plug device of claim 1, wherein the plug is comprised of a male plug.

7. The emergency power plug device of claim 1, wherein the plug is comprised of a female plug.

8. An emergency power plug device comprising:
a first end comprised of a thread, a nut, a first wire, a second wire, and a third wire; and
a second end comprised of a plug and a cap.

9. The emergency power plug device of claim 8, wherein the first wire is comprised of a positive wire.

10. The emergency power plug device of claim 8, wherein the second wire is comprised of a negative wire.

11. The emergency power plug device of claim 8, wherein the third wire is comprised of a neutral wire.

12. The emergency power plug device of claim 8, wherein the nut is comprised of a threaded locking nut.

13. The emergency power plug device of claim 8, wherein the plug is comprised of a male plug.

14. The emergency power plug device of claim 8, wherein the plug is comprised of a female plug.

15. The emergency power plug device of claim 8, wherein the cap is fixedly attached to the second end.

16. The emergency power plug device of claim 8, wherein the cap is comprised of a locking member that secures the cap to the second end.

17. The emergency power plug device of claim 16, wherein the locking member is comprised of a locking button.

18. A method of using an emergency power plug device, the method comprising the following steps:
providing an emergency power plug device comprised of a body comprised of a first end comprised of a wire and a second end comprised of a plug;
attaching the wire to an appliance;
attaching a first thread of the first end to a second thread of the appliance; and
attaching the plug to a generator or a portable power source.

19. The method of using an emergency power plug device of claim 18, wherein the plug is comprised of a male plug.

20. The method of using an emergency power plug device of claim 18, wherein the emergency power plug device is comprised of a threaded locking nut.
